(19) United States
(12) Patent Application Publication
(10) Pub. No.: US 2025/0376426 A1
(43) Pub. Date: Dec. 11, 2025

(54) MICROORGANISM COATED ORGANIC FERTILIZER HAVING EXCELLENT STORAGE STABILITY UNDER ROOM TEMPERATURE AND METHOD FOR PREPARING THE SAME

(71) Applicant: BSAC CO., INC., Gwangyang-si, Jeollanam-do (KR)

(72) Inventors: Kwang Gi PARK, Gwangyang-si (KR); Hoi Jun PARK, Gwangyang-si (KR)

(21) Appl. No.: 18/736,532

(22) Filed: Jun. 7, 2024

(30) Foreign Application Priority Data
Jun. 5, 2024 (KR) 10-2024-0073372

(51) Int. Cl. C05F 11/08; C05F 5/00; C05F 17/20; C05G 5/12; C05G 5/30

(52) U.S. Cl. CPC C05F 11/08; C05F 5/002; C05F 17/20; C05G 5/12; C05G 5/30

(57) ABSTRACT

Disclosed are a microorganism-coated organic fertilizer including an organic fertilizer and a microbial coating layer, which covers 90 area % or more of the surface of the organic fertilizer, wherein the maximum thickness of the microbial coating layer is 25% or less of the thickness of the microorganism-coated organic fertilizer and the content of microorganisms in the organic fertilizer is 1/20 or more of the content of microorganisms in the microorganism-coated organic fertilizer, and a method of preparing the same.

### CROSS-REFERENCE TO RELATED APPLICATION

This application claims priority to and the benefit of Korean Patent Application No. 2024-0073372, filed on Jun. 5, 2024, the disclosure of which is incorporated herein by reference in its entirety.

### BACKGROUND

### 1. Field of the Invention

The present invention relates to a microorganism-coated organic fertilizer with excellent storage stability at room temperature and a method of preparing the same.

### 2. Discussion of Related Art

Fertilizer is the general term for nutrients that promote the growth of crops or plants by fertilizing soil for fruit trees or forest, as well as a rice paddies and fields. Unlike nutrients that are directly applied to soil or plants to maintain or improve soil productivity and promote crop or vegetation growth, fertilizers are generally defined as substances that indirectly help crops grow by improving the physicochemical properties of the soil, promoting or suppressing useful microorganisms, converting nutrients, which cannot be directly used by plants, into usable forms, or reducing the toxicity of substances that are toxic to the roots.

Among plants, higher plants absorb water and inorganic nutrients from their roots and use solar energy to photosynthesize and synthesize various organic substances, which are essential for growth, in their leaves. Since native plants grow by absorbing nutrients and die in a certain location, there is little loss of nutrients in the soil in their habitat, and they can grow quite well. On the other hand, crops in agricultural fields absorb nutrients in the rhizosphere, and after growth, the harvested products are transported to other places, so the absorbed nutrients are not returned to the soil. Therefore, when the nutrients consumed during the crop growth stage are not artificially supplied in a timely manner, the productivity of the crop can decrease every year. In order to maintain or increase the productivity of the land and maintain the productivity of the crop, fertilization and management are required depending on the type of crops and soil.

Accordingly, chemical fertilizers (inorganic fertilizers) have been used since the 1960s to increase the productivity of the crop. When an appropriate amount of chemical fertilizer is used, cultivated crops can grow rapidly and in turn increase profits. However, excessive fertilization can cause acidification of the soil in the cultivation area, salt stress to soil due to the accumulation of salts, and devastation of farmlands as the soil ecosystem is destroyed by inhibiting the growth of microorganisms, which are the final decomposers.

To solve these problems, instead of chemical fertilizers, organic fertilizers were proposed. Organic fertilizers decompose organic matter by fermenting it with microorganisms and provide nutrients that plants can use. When organic fertilizers are applied to cultivation areas, inorganic nutrients (N, P, K) and trace elements (Mg, Mn, Cu, b, Mo, etc.) are supplied as nutrients for cultivated crops, which not only stimulates growth, but also forms physical pores in the soil so that amino acids, nucleic acids, organic acids, vitamins, etc. can be supplied so that soil rhizosphere microorganisms can establish themselves, and due to organic acids secreted by the restored rhizospheric organisms, inorganic salts around the roots are ionized so that they can be easily absorbed by crops, and thus, it is possible to alleviate salt accumulation.

However, when animal or plant materials, which are raw materials for organic fertilizers, are used as raw materials, cellulose, lignin, etc. cannot be easily absorbed by plants because it is difficult for plants to decompose them, and when there are not enough microorganisms that can decompose and ferment them in the soil, decay may occur due to anaerobic fermentation and harmful gases may be generated.

Therefore, organic fertilizers containing microorganisms have been proposed. For example, Patent Document 1 discloses an organic compound fertilizer prepared by mixing a microbial liquid with organic matter containing rice bran, oil meal, and fish meal. However, unlike conventional chemical fertilizers (inorganic fertilizers), since organic fertilizers lack the binding force between materials, when organic matter and a microbial liquid are simply mixed and prepared as in Patent Document 1, the microbial liquid penetrates into the center of organic fertilizers, and thus organic fertilizers are often damaged during the drying and cooling process.

In order to solve the above problem, the present applicants proposed a technology for forming a microbial coating layer on the surface of organic fertilizer by spraying and drying a microbial culture solution on the organic fertilizer surface (Patent Document 2). When a microbial coating layer is formed by spraying and drying a microbial culture solution as in Patent Document 2, the microbial culture solution is absorbed only into the organic fertilizer surface, and the mechanical strength of the organic fertilizer can be improved.

### RELATED ART DOCUMENTS

### Patent Documents

(Patent Document 1) Korean Registered Patent Gazette No. 298785

(Patent Document 2) Korean Registered Patent Gazette No. 2538072

### SUMMARY OF THE INVENTION

However, in the organic fertilizer according to Patent Document 2, since microorganisms are distributed only on the organic fertilizer surface, the microorganism content in the organic fertilizer rapidly decreases when the organic fertilizer is stored at room temperature for a long time.

The purpose of the present invention is to solve the above problem and provide a microorganism-coated organic fertilizer with excellent storage stability at room temperature and a method of preparing the same.

According to an aspect of the present invention, there is provided a microorganism-coated organic fertilizer including an organic fertilizer and a microbial coating layer, which covers 90 area % or more of the organic fertilizer surface, wherein the maximum thickness of the microbial coating layer is 25% or less of the thickness of the microorganism-coated organic fertilizer, and the content of microorganisms in the organic fertilizer is 1/20 or more of the content of microorganisms in the microorganism-coated organic fertilizer.

In an embodiment, the organic fertilizer may include castor meal; rice meal; and one or more of rapeseed oil meal, palm oil meal, and processed chicken manure.

In an embodiment, the organic fertilizer may include 10 to 95 wt % of castor meal; 1 to 50 wt % of rice meal; and 4 to 80 wt % of one or more of rapeseed oil meal, palm oil meal, and processed chicken manure.

In an embodiment, the microorganism may be at least one selected from the group consisting of the genus Bacillus, Lactobacillus, Saccharomyces, Pseudomonas, Aspergillus, Rhodotorula, Streptomyces, and Thermoascus.

In an embodiment, the organic fertilizer may be in the form of pellets or granules.

According to another aspect of the present invention, there is provided a method of preparing a microorganism-coated organic fertilizer including: (a) kneading and grinding organic raw materials; (b) preparing an organic fertilizer by molding the mixture of step (a) into pellets or granules; (c) inputting the organic fertilizer into a cylindrical rotating housing, which is inclined to form a downward slope from the inlet to the outlet and rotates at a predetermined speed by external power; and (d) forming and drying a microbial coating layer, which covers 90 area % or more of the organic fertilizer surface, by spraying a microbial culture solution while supplying hot air to the inside of the cylindrical rotating housing, wherein the moisture content of the organic fertilizer input into the cylindrical rotating housing in step (c) is 16 to 24%.

In an embodiment, in step (d), the spraying of the microbial culture solution may be performed by a spray nozzle, in which a plurality of spray holes are formed, and the length of the spray nozzle may be ⅓ or less of the length of the cylindrical rotating housing.

In an embodiment, the temperature of the hot air supplied in step (d) may be 35 to 80° C.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a configuration diagram of the fertilizer processing part 100 used in the present invention;

FIG. 2 is a schematic illustration of the fertilizer processing part 100 used in the present invention; and

FIG. 3 is an exemplary cross-sectional view taken along line A-A of FIG. 2.

### DETAILED DESCRIPTION OF EXEMPLARY EMBODIMENTS

The advantages and features of the present invention and methods for achieving the same will become clear by referring to the following embodiments described in detail with the attached drawings.

However, the present invention is not limited to the embodiments disclosed below and may be implemented in various forms, and the embodiments of the present invention are only intended to complete the disclosure of the present invention and inform those skilled in the art of the scope of the present invention, and the present invention is only defined by the scope of the claims.

Accordingly, in some embodiments, well-known process steps, well-known structures, and well-known techniques are not specifically described in order to avoid being ambiguously interpreted of the present invention.

The terminology used herein is for the purpose of describing embodiments and is not intended to limit the prevent invention. In this specification, singular forms also include plural forms unless specifically stated otherwise in the context.

Throughout this specification, when a part is said to be “connected” to another part, this includes not only the case where it is “directly connected,” but also the case where it is “indirectly connected” with another member interposed therebetween. When a part is said to “include” a certain component, this means that it may further include other components rather than excluding other components, unless specifically stated to the contrary.

Throughout this specification, the upper and lower parts mean being located above or below the target member, and do not necessarily mean being located above or below the target member, based on the direction of gravity.

When a range of numerical values is described herein, unless the specific range is stated, the value has the precision of significant figures given in accordance with the standard rules in chemistry for significant figures. For example, the number 10 ranges from 5.0 to 14.9, and the number 10.0 ranges from 9.50 to 10.49.

Hereinafter, an aspect of the present invention, which is a microorganism-coated organic fertilizer with excellent storage stability at room temperature, will be described in detail.

According to an aspect of the present invention, there is provided a microorganism-coated organic fertilizer including an organic fertilizer and a microbial coating layer, which covers 90 area % or more of the organic fertilizer surface, wherein the maximum thickness of the microbial coating layer is 25% or less of the thickness of the microorganism-coated organic fertilizer, and the content of microorganisms in the organic fertilizer is 1/20 or more of the content of microorganisms in the microbial coating layer.

When the microorganism-coated organic fertilizer of the present invention is applied to the soil, due to the organic components in the organic fertilizer, microorganisms in the soil multiply, the fermentation rate of organic components increases due to the proliferated microorganisms, thereby increasing the growth rate of crops and obtaining high-quality fruits.

Conventionally, organic fertilizers have been used by including livestock excrement, waste containing organic matter, or plant materials as the main raw material, but due to difficulties in storage and use, they are manufactured in a solid form for use. When livestock excrement, food waste, etc. are used as the main raw material, there is an inconvenience in that the fertilizer has to undergo artificial rotting (fermentation) during the preparation process, and when the fertilizer is applied, a peculiar odor and weeds may occur frequently.

In contrast, the organic fertilizer of the present invention includes castor meal and rice bran, and since the organic fertilizer further includes at least one selected from the group consisting of rapeseed oil meal, palm oil meal, and processed chicken manure depending on the condition or type of soil, to which the organic fertilizer is applied, it does not generate a bad odor, which may make it more useful.

Unlike chemical fertilizers or complex fertilizers that artificially increase the NPK (nitrogen, phosphorus, potassium) content, causing problems in the growth of crops and pests and diseases, and ultimately leading to the use of pesticides, since the microorganism-coated organic fertilizer of the present invention includes plant raw materials such as castor meal, rapeseed oil meal, palm oil meal, and rice bran, the sum of the component content including nitrogen (N), phosphorus (P), and potassium (K) (total nitrogen, phosphorus oxide, and potassium oxide) is 10 wt % or more without artificially increasing the NPK content, and thus it is possible to effectively stimulate crop growth without pesticides.

The castor meal, rapeseed oil meal, and palm oil meal refer to the by-products remaining after extracting oil from the seeds that serve as raw materials. Specifically, the castor meal is the by-product remaining after extracting oil from the castor fruit, the rapeseed oil meal is the by-product remaining after extracting oil from rape seeds, and the palm oil meal is the by-product remaining after extracting oil from palm seeds. The castor meal, rapeseed oil meal, and palm oil meal may contain a relatively high content of nitrogen compared to animal raw materials.

Based on the total weight of the organic fertilizer, the content of the castor meal may be 10 wt % to 95 wt %, for example, 10 wt %, 15 wt %, 20 wt %, 25 wt %, 30 wt %, 35 wt %, 40 wt %, 45 wt %, 50 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 90 wt %, or 95 wt %, but is not necessarily limited thereto. When the content of castor meal is outside the above range, the nitrogen content in the fertilizer may decrease.

The rice bran is the by-product generated when brown rice is milled into white rice, and can be used as feed, compost, or eco-friendly materials because it has a high phosphoric acid content. The rice bran may serve as a lubricant so that each raw material of the organic fertilizer may be uniformly mixed due to an oil component contained in it, and the rice bran may strengthen the binding force with the microbial coating layer, which will be described later. Each raw material may be uniformly mixed to increase the binding force between raw materials. Based on the total weight of the organic fertilizer, the content of the rice bran may be 1 wt % to 50 wt %, for example, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 20 wt %, 25 wt %, 30 wt %, 35 wt %, 40 wt %, 45 wt %, or 50 wt %, but is not necessarily limited thereto. When the content of rice bran is outside the above range, the effect as the above-described lubricant may be insufficient, solidification of the fertilizer may become difficult, or the binding force with the coating layer, which will be described later, may be weakened.

When the organic fertilizer further includes at least one selected from the group consisting of rapeseed oil meal, palm oil meal, and processed chicken manure, based on the total weight of the organic fertilizer, their total content may be 4 wt % to 80 wt %, for example, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 45 wt %, 50 wt %, 55 wt %, 60 wt %, 65 wt %, 70 wt %, 75 wt %, or 80 wt %, but is not necessarily limited thereto.

Specifically, the rapeseed oil meal content may be, for example, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, or 30 wt %, but is not necessarily limited thereto. In addition, the palm oil meal content may be, for example, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, or 15 wt %, but is not necessarily limited thereto. In the case where the rapeseed oil meal or palm oil meal is further included, when each content is added outside the above range, the coating properties of the fertilizer may be reduced.

The processed chicken manure content may be, for example, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, or 25 wt %, but is not necessarily limited thereto.

Generally, chicken manure has a high content of fertilizer components such as nitrogen, phosphoric acid, and potassium compared to cow manure and pig manure, making it highly valuable as a raw material for fertilizers, and since the composition of feed is generally constant, the difference in the composition of chicken manure is not significant. However, since the raw material itself has a lot of moisture, it may be applied as an organic fertilizer through a fermentation or drying process. Chicken manure may be manufactured in the form of dried chicken manure, processed chicken manure through fermentation for a certain period of time, and compost through decay and fermentation. In particular, since processed chicken manure goes through fermentation for a certain period of time, it may be more stable for crop growth than dried chicken manure, and the processed chicken manure may reduce nutrient loss due to its short fermentation time compared to the compost.

The processed chicken manure may be manufactured by mixing sawdust with chicken manure as the raw material, and going through fermentation, and may be a mixture of chicken manure and sawdust at a weight ratio of 70 to 90:10 to 30. When the chicken manure is mixed with sawdust, the moisture of the chicken manure may be adjusted and the bad odor may be reduced, making it easy to handle and apply as an organic fertilizer. The processed chicken manure may be mixed with the above-described plants raw materials, that is, castor meal, rapeseed oil meal, and palm oil meal, to improve the performance of the organic fertilizer, thereby increasing crop productivity.

The organic fertilizer may be in the form of pellets or granules. Specifically, since the organic fertilizer is prepared as solid particles such as pellets or granules, the generation of dust may be minimized when the fertilizer is transported, and since the fertilizer is uniformly sprayed when applied, convenience may be improved.

The average particle diameter of the organic fertilizer may be 1 to 10 mm, for example, 1 mm, 2 mm, 3 mm, 4 mm, 5 mm, 6 mm, 7 mm, 8 mm, 9 mm, or 10 mm, but is not limited thereto. When the average particle diameter of the organic fertilizer is less than 1 mm, the risk of the organic fertilizer loss may increase, and when the average particle diameter of the organic fertilizer is more than 10 mm, the mechanical properties of the organic fertilizer may decrease.

The microorganism-coated organic fertilizer of the present invention includes a microbial coating layer formed on at least a portion of the organic fertilizer surface.

Organic fertilizers, which are prepared using organic components such as oil meal, processed chicken manure, and rice bran as main raw materials, have already undergone fermentation, and although artificial composting is not necessarily required, organic fertilizers may go through fermentation with microorganisms in the soil after being applied to the soil and supply nutrients to the soil. However, when the fermentation speed of organic fertilizers is slower than that of livestock manure and the supply of microorganisms is not smooth due to soil deterioration, the soil improvement effect of organic fertilizers may be significantly reduced.

However, in the present invention, since a microbial coating layer is formed on at least portion of the organic fertilizer surface, it is possible to achieve a great soil improvement effect even when microorganisms are not sufficiently supplied due to soil deterioration.

In order to achieve the above effect, the microbial coating layer may coat, for example, 90 area %, 91 area %, 92 area %, 93 area %, 94 area %, 95 area %, 96 area %, 97 area %, 98 area %, 99 area %, or 100 area % of the organic fertilizer surface, but is not necessarily limited thereto.

The microbial coating layer may be formed by spraying and drying a liquid microbial culture solution.

For example, the maximum thickness of the microbial coating layer may be 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, or 1% of the thickness of the microorganism-coated organic fertilizer, but is not necessarily limited thereto. Since organic fertilizers have a relatively low binding force between materials compared to conventional chemical fertilizers (inorganic fertilizers), when a microbial culture solution penetrates into the center of organic fertilizers, there is a risk of damage during the drying and cooling process or during the storage or transportation of the final product. However, in the present invention a decrease in mechanical strength may be prevented by adjusting the maximum thickness of the microbial coating layer to a certain level or less. The microbial coating layer and the organic fertilizer in the layer may be easily distinguished by their colors. Meanwhile, the present invention does not specifically limit the method of adjusting the maximum thickness of the microbial coating layer, but for example, when a microbial coating layer is formed using a fertilizer processing part, which is described later, the maximum thickness of the microbial coating layer may be adjusted by controlling the rotational speed of a cylindrical rotating housing, the residence time in the cylindrical rotating housing, and the temperature and intensity of hot air.

In the present invention, the content of microorganisms in the organic fertilizer is 1/20 or more, preferably 1/15 or more, more preferably 1/12 or more, for example, 1/20 or more, 1/19 or more, 1/18 or more, 1/17 or more, 1/16 or more, 1/15 or more, 1/14 or more, 1/13 or more, 1/12 or more, 1/11 or more, or 1/10 or more, of the content of microorganisms in the microorganism-coated organic fertilizer, but is not necessarily limited thereto. In the organic fertilizer according to the above-described Patent Document 2, since microorganisms are distributed only on the organic fertilizer surface, when the organic fertilizer is stored at room temperature for a long time, the content of microorganisms in the organic fertilizer rapidly decreases. However, in the present invention, since at least 1/20 of the microorganisms spread into the organic fertilizer, microorganisms may survive even when the organic fertilizer is stored at room temperature for a long time, and thus the storage stability of the organic fertilizer at room temperature may be significantly improved. Here, the content of microorganisms in the organic fertilizer is the content of microorganisms measured after peeling microbial coating layer off the microorganism-coated organic fertilizer.

The content of microorganisms in the microorganism-coated organic fertilizer may be 1.0×10⁶ to 1.0×10¹⁰ cfu/ml, preferably 1.0×10⁷ to 5.0×10⁹ cfu/ml, more preferably 5.0×10⁷ to 1.0×10⁹ cfu/ml, but is not limited thereto. Here, the content of microorganisms refers to the number of colonies (population) in 1 ml of the aqueous solution when the fertilizer is powdered and 1 g of the powdered fertilizer is dissolved in about 9 ml of distilled water to make 10 ml of the aqueous solution.

The present invention does not specifically limit the method of spreading microorganisms into the organic fertilizer, but the method may include, for example, appropriately managing the moisture content of the organic fertilizer before forming the microbial coating layer or the microbial coating and hot air-drying conditions.

The microorganisms may be at least one selected from the group consisting of the genus Bacillus, Lactobacillus, Saccharomyces, Pseudomonas, Aspergillus, Rhodotorula, Streptomyces, and Thermoascus, preferably the genus Bacillus, but are not necessarily limited thereto.

The microorganisms of the genus Bacillus may be at least one selected from the group consisting of Bacillus subtilis and Bacillus megaterium, but is not necessarily limited thereto.

The microorganisms of the genus Lactobacillus may be at least one selected from the group consisting of Lactobacillus casei, Lactobacillus plantarum, Lactobacillus reuteri, Lactobacillus acidophilus, and Lactobacillus bulgaricus, but are not necessarily limited thereto.

The microorganisms of the genus Saccharomyces may be Saccharomyces cerevisiae, but is not necessarily limited thereto.

The microorganisms of the genus Pseudomonas may be Pseudomonas protegens, but is not necessarily limited thereto.

The microorganisms of the genus Aspergillus may be Pseudomonas protegens, but is not necessarily limited thereto.

The microorganisms of the genus Rhodotorula may be Rhodotorula aurantiaca, but is not necessarily limited thereto.

The microorganisms of the genus Streptomyces may be Streptomyces costaricanus, but is not necessarily limited thereto.

The microorganisms of the genus Thermoascus may be Thermoascus thermophilus, but is not necessarily limited thereto.

In an embodiment of the present invention, the microbial coating layer may further include a liquid fertilizer, which is a liquid fertilizer generated in the process of recycling organic waste resources, for example, after food waste is digested under anaerobic conditions and the liquid component is separated from the digested mixture to be used as a liquid fertilizer, or the separated liquid component is composted by injecting air or air and microorganisms to use as a liquid fertilizer, but it is not necessarily limited thereto. Any liquid fertilizer generated in the process of recycling organic waste resources may be used without particular limitation. Raw materials for the liquid fertilizer may include sesame meal, alcohol, soybeans, palm oil, bone powder, and eggshell, which contain a large amount of NPK (nitrogen, phosphorus, and potassium) and may effectively improve the growth of crops.

Hereinafter, as another aspect of the present invention, the method of preparing a microorganism-coated organic fertilizer with excellent storage stability at room temperature will be described in detail.

The method of preparing a microorganism-coated organic fertilizer with excellent storage stability at room temperature according to another aspect of the present invention includes: (a) kneading and grinding organic raw materials; (b) preparing an organic fertilizer by molding the mixture of step (a) into pellets or granules; (c) inputting the organic fertilizer into a cylindrical rotating housing that is inclined to form a downward slope from the inlet to the outlet and rotates at a predetermined speed by external power; and (d) forming and drying a microbial coating layer, which covers 90 area % or more of the organic fertilizer surface, by spraying a microbial culture solution while supplying hot air to the inside of the cylindrical rotating housing.

In step (a), a mixture is prepared by kneading and grinding organic raw materials, and the organic raw materials may be castor meal; rice meal; and one or more of rapeseed oil meal, palm oil meal, and processed chicken manure. The physical properties, content, and specific effects of each organic raw material are as described above.

In step (b), an organic fertilizer is prepared by inputting the mixture of step (a) into a molding machine and molding the mixture into pellets or granules. Step (b) may be performed at a molding temperature of 300 to 500° C., for example, 300° C., 325° C., 350° C., 375° C., 400° C., 425° C., 450° C., 475° C., 500° C., or a temperature between two of these values. When the molding temperature is less than 300° C., the moldability of the organic fertilizer may be reduced, and when the molding temperature exceeds 500° C., the organic fertilizer may be destroyed due to the excessively high temperature.

In step (c), the organic fertilizer of step (b) is input into a cylindrical rotating housing that is inclined to form a downward slope from the inlet to the outlet and rotates at a predetermined speed by external power.

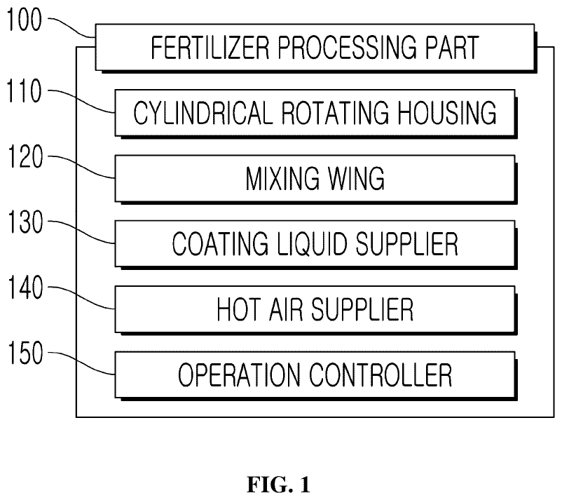

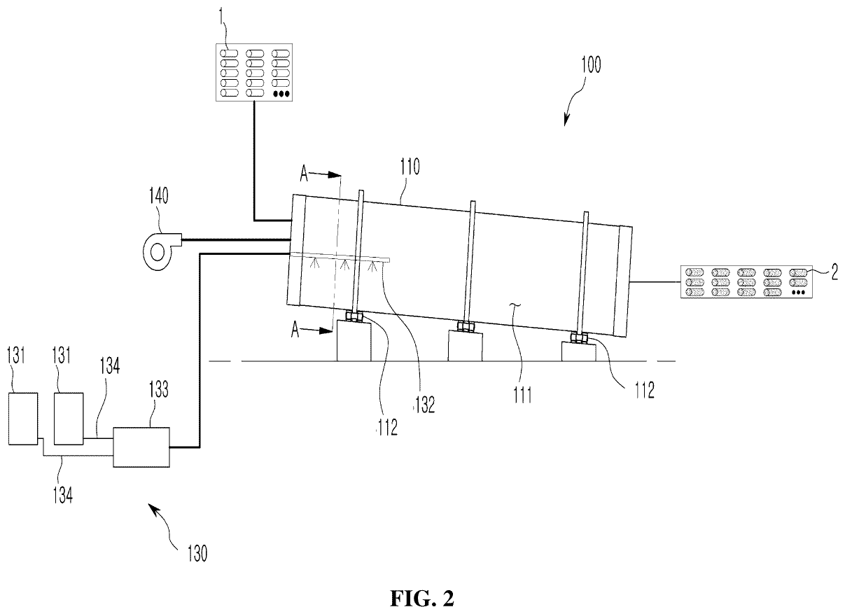

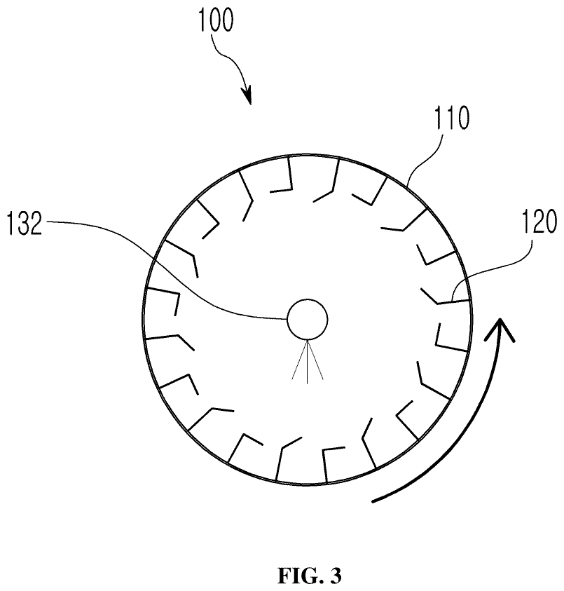

FIG. 1 is a configuration diagram of a fertilizer processing part 100 used in step (c), FIG. 2 is a schematic illustration of the fertilizer processing part 100, and FIG. 3 is an exemplary cross-sectional view taken along line A-A of FIG. 2.

The fertilizer processing part 100 prepares a microorganism-coated organic fertilizer 2 using an organic fertilizer 1 supplied from the molding machine.

The fertilizer processing part 100 may include a cylindrical rotating housing 110, a mixing wing 120, a coating liquid supplier 130, a hot air supplier 140, and an operation controller 150.

The cylindrical rotating housing 110 forms the outer shape of the fertilizer processing part 100.

In the cylindrical rotating housing 110, there is an empty processing space 111, in which the organic fertilizer 1 is accommodated.

An inlet, through which the organic fertilizer 1 supplied from the molding machine flows, is formed at one end of the cylindrical rotating housing 110, and an outlet, through which the microorganism-coated organic fertilizer 2 is discharged, is formed at the other end of the cylindrical rotating housing 110.

The organic fertilizer 1 input through the inlet is coated with microorganisms as it moves along the longitudinal direction of the cylindrical rotating housing 110, and the microorganism-coated organic fertilizer 2 may be prepared.

The moisture content of the organic fertilizer input into the cylindrical rotating housing may be 16 to 24%, for example, 16%, 17%, 18%, 19%, 20%, 21%, 22%, 23%, 24%, or a value between two of these values. When the moisture content of the organic fertilizer is excessively low, microorganisms may not sufficiently spread into the organic fertilizer. On the other hand, when the moisture content of the organic fertilizer is excessively high, the microbial coating layer may not be properly dried. The moisture content of the organic fertilizer may be controlled by adjusting the moisture content supplied through a steamer through which moisture is supplied before the mixture in step (a) is input into the molding machine, but it is not limited thereto.

The cylindrical rotating housing 110 is inclined to form a downward slope from the inlet to the outlet.

The cylindrical rotating housing 110 may be rotated by rotating rollers 112 while being supported on the rotating rollers 112. While the cylindrical rotating housing 110 is rotated, the organic fertilizer 1 supplied to the processing space 111 may move along the longitudinal direction of the cylindrical rotating housing 110. In this process, the organic fertilizer 1 may be prepared into the microorganism-coated organic fertilizer 2.

The rotating rollers 112 may rotate the cylindrical rotating housing 110 at a required rotational speed due to power supplied from a rotation power unit (not shown).

The hot air supplier 140 is coupled to one end of the cylindrical rotating housing 110. The hot air supplier 140 is configured to supply hot air to the processing space 111.

The hot air supplied from the hot air supplier 140 dries the microorganism-coated organic fertilizer moving in the processing space 111 and spreads microorganisms into the microbial coating layer.

The operation controller 150 may selectively control the intensity or temperature of hot air supplied from the hot air supplier 140. In this way, the operation controller 150 may adjust the content of microorganisms spread into the microbial coating layer by selectively controlling the temperature and intensity of hot air of the hot air supplier 140.

The temperature of the hot air supplied from the hot air supplier 140 may be 35 to 80° C., preferably 45 to 70° C., more preferably 50 to 65° C., and it may be, for example, 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., or a value between two of these values. When the temperature of the hot air is excessively low, the drying of the microbial coating layer may not be performed properly, and when the temperature of the hot air is excessively high, microorganisms may not sufficiently spread into the organic fertilizer.

Mixing wings 120 are provided in the cylindrical rotating housing 110.

Mixing wings 120 ensure that the hot air supplied from the hot air supplier 140 is effectively supplied to the organic fertilizer 1.

Such mixing wings 120 protrude at predetermined intervals along the circumference of the cylindrical rotating housing 110. In addition, the mixing wings 120 may be arranged at predetermined intervals in the longitudinal direction of the cylindrical rotating housing 110.

The mixing wings 120 is configured so that the organic fertilizer 1 contained in the processing space 111 is mixed during the rotation of the cylindrical rotating housing 110 and hot air is effectively supplied between the plurality of organic fertilizers 1. Thus, the efficiency of drying organic fertilizer 1 may be further increased.

The coating liquid supplier 130 is coupled to one end of the cylindrical rotating housing 110.

The coating liquid supplier 130 sprays a microbial culture solution into the processing space 111 to perform microbial coating treatment on the outer surface of the organic fertilizer 1.

Since the coating liquid supplier 130 controls the type and content of the microbial culture solution sprayed on the organic fertilizer 1, the outer surface of the finally prepared microorganism-coated organic fertilizer 2 may be coated with a desired type of microorganism and thickness.

The coating liquid supplier 130 may include a coating liquid tank 131, a spray nozzle 132, and a metering pump 133.

There may be a plurality of coating liquid tanks 131. In other words, each coating liquid tank 131 may contain a different microbial culture solution.

Each coating liquid tank 131 is connected to the metering pump 133, and the microbial culture solution may be supplied to the spray nozzle 132 by the operation of the metering pump 133.

Valves (not shown) may be provided in connection pipes 134 through which the coating liquid tanks 131 and the metering pump 133 are connected, and the operation controller 150 may selectively control the opening and closing of the valves.

Accordingly, the operation controller 150 may process the microbial coating of the microorganism-coated organic fertilizer 2 in various ways through valve control. For example, the operation controller 150 may perform valve control so that only a first microbial culture solution contained in a first coating liquid tank is sprayed on the organic fertilizer 1 and that only a second microbial culture solution contained in a second coating liquid tank is sprayed on the organic fertilizer 1. Alternatively, the operation controller 150 may perform valve control so that a mixed microbial culture solution, which is a mixture of the first microbial culture solution and the second microbial culture solution, is sprayed on the organic fertilizer 1. In the case of the mixed microbial culture solution, the mixing ratio of the first microbial culture solution and the second microbial culture solution may be selectively controlled by adjusting the opening and closing amount of the valves provided in each connection pipe 134.

FIG. 2 illustrates an example in which two coating liquid tanks 131 are provided, but the number of coating liquid tanks 131 is not necessarily limited to two and may be provided in various numbers.

The metering pump 133 is configured to supply the microbial culture solution to the spray nozzle 132 at a predetermined pressure. The operation of the metering pump 133 may also be controlled by the operation controller 150.

The spray nozzle 132 is connected to the metering pump 133 and is configured to spray the microbial culture solution supplied from the metering pump 133 on the organic fertilizer 1.

The spray nozzle 132 is provided at one end of the cylindrical rotating housing 110 and disposed in the processing space 111. The spray nozzle 132 is provided at one end of the cylindrical rotating housing 110 and is configured to spray the microbial culture solution on the outer surface of the organic fertilizer 1 supplied to the cylindrical rotating housing 110 through the inlet. In other words, the spray nozzle 132 is configured to spray the microbial culture solution on the organic fertilizer 1 in one side of the cylindrical rotating housing 110.

A plurality of spray holes (not shown) are formed in the spray nozzle 132 so that the microbial culture solution sprayed from the spray holes may be sprayed on the organic fertilizer 1 in one side of the cylindrical rotating housing 110.

The length of the spray nozzle 132 is ⅓ or less of the length of the cylindrical rotating housing 110, and the microbial culture solution is sprayed on the organic fertilizer 1. Thus, while the organic fertilizer 1 is moving to the other side of the cylindrical rotating housing 110 with the microbial culture solution applied on the outer surface of the organic fertilizer 1, a microbial coating layer is effectively dried due to the hot air supplied from the hot air supplier 140 and at the same time, the microorganisms in the microbial coating layer effectively spread into the organic fertilizer.

That is, when the length of the spray nozzle 132 exceeds ⅓ of the length of the cylindrical rotating housing 110, the microbial culture solution applied on the outer surface of the organic fertilizer 1 may not be dried properly or microorganisms may not sufficiently spread into the organic fertilizer.

Therefore, the length of the spray nozzle 132 is preferably ⅓ or less of the length of the cylindrical rotating housing 110 and more preferably ¼ or less of the length of the cylindrical rotating housing 110 in order to effectively dry the microbial culture solution and sufficiently spread microorganisms.

Hereinafter, examples of the present specification will be described in more detail. However, the following experimental results describe only representative experimental results among the examples, and the scope and content of the present specification cannot be interpreted as being reduced or limited by the examples. Each effect of various implementations of the present specification that are not explicitly presented below will be described in detail in the corresponding section.

### Comparative Example 1

80 wt % of castor meal, 10 wt % of rapeseed oil meal, 5 wt % of palm oil meal, and 5 wt % of rice bran were added to a grinder and kneaded and ground to prepare a mixture.

Afterward, the prepared mixture was put into a molding machine and extruded at 400° C. to mold an organic fertilizer in the form of pellets.

Afterward, the molded organic fertilizer was put into a drum-type coating machine and rotated while a Bacillus megaterium culture solution (1.9×10⁹ cfu/ml) was sprayed to coat the surface of the organic fertilizer with the culture solution, and then the coated organic fertilizer was cooled and dried in a cooler at 5° C. for 2 hours to prepare a microorganism-coated organic fertilizer. The coverage rate of the microbial coating layer was 100 area %, and the maximum thickness of the microbial coating layer was about 8% of the thickness of the microorganism-coated organic fertilizer. Here, the maximum thickness of the microbial coating layer is the maximum thickness of the microbial coating layer in a cross section of a pellet-shaped organic fertilizer cut perpendicular to the longitudinal direction.

### Example 1

80 wt % of castor meal, 10 wt % of rapeseed oil meal, 5 wt % of palm oil meal, and 5 wt % of rice bran were added to a grinder and kneaded and ground to prepare a mixture.

The prepared mixture was put into a steamer to supply moisture so that the moisture content was 18%, and then put into a molding machine and extruded at 400° C. to mold the organic fertilizer into the form of pellets.

Afterward, the molded organic fertilizer was put into the fertilizer processing part of FIG. 2 and rotated, while a Bacillus megaterium culture solution (1.9×10⁹ cfu/ml) was sprayed to coat the surface of the organic fertilizer with the culture solution and dried with hot air to prepare a microorganism-coated organic fertilizer. The temperature of the hot air supplied to the fertilizer processing part was 60° C. The coverage rate of the microbial coating layer was 100 area %, and the maximum thickness of the microbial coating layer was about 8% of the thickness of the microorganism-coated organic fertilizer.

### Experimental Example 1: Evaluation of Mechanical Properties of Microorganism-Coated Organic Fertilizer

In order to confirm the mechanical properties of organic fertilizers prepared in Example and Comparative Example, impact strength and tensile strength were measured, and the results thereof are shown in Table 1 below.
Impact strength (⅛″, kgf/cm²): was measured according to the ASTM D256 standard.
Tensile strength (kgf/cm²): was measured according to the ASTM D638 standard.

TABLE 1

| Classification | Impact strength | Tensile strength |
|---|---|---|
| Comparative Example 1 | 10.4 | 251 |
| Example 1 | 10.3 | 248 |

Referring to Table 1, it can be seen that both microorganism-coated organic fertilizers of Example 1 and Comparative Example 1 had excellent mechanical properties, with an impact strength of more than 9.0 kgf/cm² and a tensile strength of more than 220 kgf/cm². Therefore, it can be confirmed that both microorganism-coated organic fertilizers of Example 1 and Comparative Example 1 may be sprayed without damage or loss during fertilization.

### Experimental Example 2: Measurement of Microorganism Content of Microorganism-Coated Organic Fertilizer

The content of microorganisms (A) in the microorganism-coated organic fertilizers of Example 1 and Comparative Example 1 was measured. After removing the microbial coating layer of the microorganism-coated organic fertilizers of Example 1 and Comparative Example 1, the content of microorganisms (B) in the organic fertilizers was measured, and the results thereof are shown in Table 2 below.

TABLE 2

| Classification | A | B | B/A |
|---|---|---|---|
| Comparative | 1.08 × 10⁸ cfu/ml | 5.62 × 10³ cfu/ml | 0.000052 |
| Example 1 | | | |
| Example 1 | 1.10 × 10⁸ cfu/ml | 1.23 × 10⁷ cfu/ml | 0.11 |

Referring to Table 2, given that the microorganism-coated organic fertilizer of Example 1 had a B/A of more than 1/20, it can be confirmed that a large number of microorganisms spread into the organic fertilizer inside the microbial coating layer. On the other hand, given that the microorganism-coated organic fertilizer of Comparative Example 1 had a B/A of 0.000052, it can be confirmed that microorganisms hardly spread, and most microorganisms were present inside the microbial coating layer.

### Experimental Example 3: Evaluation of Room Temperature Storage Stability of Microorganism-Coated Organic Fertilizer

The microorganism-coated organic fertilizers of Example 1 and Comparative Example 1 were stored at room temperature (25° C.), and the microorganism content was measured over 150 days. The results are shown in Table 3 below.

TABLE 3

| Elapsed time | | Comparative Example 1 | Comparative Example 2 |
|---|---|---|---|
| 0 | days | 1.08 × 10⁸ cfu/ml | 1.10 × 10⁸ cfu/ml |
| 30 | days | 9.52 × 10⁷ cfu/ml | 1.09 × 10⁸ cfu/ml |
| 60 | days | 8.13 × 10⁷ cfu/ml | 1.08 × 10⁸ cfu/ml |
| 90 | days | 6.83 × 10⁷ cfu/ml | 1.09 × 10⁸ cfu/ml |
| 120 | days | 5.57 × 10⁷ cfu/ml | 1.07 × 10⁸ cfu/ml |
| 150 | days | 4.35 × 10⁷ cfu/ml | 1.07 × 10⁸ cfu/ml |

Referring to Table 3, given that the microorganism-coated organic fertilizer of Example 1 had a microorganism content of 95% or more of the initial microorganism content after being stored at room temperature for 150 days, it can be confirmed that room temperature storage stability was excellent. On the other hand, the microorganism-coated organic fertilizer of Comparative Example 1 had a microorganism content of about 40% of the initial microorganism content after being stored at room temperature for 150 days and reached a level that required additional input of microorganisms during fertilization.

The microorganism-coated organic fertilizer according to the present invention has a long microorganism survival time as a large number of microorganisms penetrate into a microbial coating layer, thereby having excellent storage stability at room temperature.

The microorganism-coated organic fertilizer according to the present invention has high usability because it has a high NPK (nitrogen, phosphorous, potassium) content, reduces weeds, and do not generate a bad odor when applied.

When the microorganism-coated organic fertilizer according to the present invention is applied to the soil, due to the organic components in the organic fertilizer, microorganisms in the soil multiply, and the fermentation rate of organic components increases due to the proliferated microorganisms, thereby promoting crop growth, accelerating the growth rate, and producing high-quality fruits.

The effects of one aspect of the present invention are not limited to the above-described effects and should be understood as including all effects that can be inferred from the configurations described in the detailed description or claims of the present invention.

The description of the present specification described above is for illustrative purposes, and a person skilled in the art to which an aspect of the present specification pertains can easily transform it into another specific form without changing the technical idea or essential features described herein. Therefore, the embodiments described above should be understood in all respects as illustrative and not restrictive.

The scope of the present specification is indicated by the claims described below, and all changes or modified forms derived from the meaning and scope of the claims and their equivalent concepts should be construed as being included in the scope of the present specification.

[Description of the reference numbers]

| | |
|---|---|
| 1: Organic fertilizer | 2: Microorganism-coated organic fertilizer |
| 100: Fertilizer processing part | 110: Cylindrical rotating housing |
| 111: Processing space | 112: Rotating roller |
| 120: Mixing wing | 130: Coating liquid supplier |
| 131: Coating liquid tank | 132: Spray nozzle |
| 133: Metering pump | 134: Connection pipe |
| 140: Hot air supplier | 150: Operation controller |

1. A microorganism-coated organic fertilizer comprising:
an organic fertilizer; and
a microbial coating layer covering 90 area % or more of the surface of organic fertilizer,
wherein the maximum thickness of the microbial coating layer is 25% or less of the thickness of the microorganism-coated organic fertilizer, and the content of microorganisms in the organic fertilizer is 1/20 or more of the content of microorganisms in the microorganism-coated organic fertilizer.

2. The fertilizer of claim 1, wherein the organic fertilizer includes castor meal; rice meal; and one or more of rapeseed oil meal, palm oil meal, and processed chicken manure.

3. The fertilizer of claim 2, wherein the organic fertilizer includes 10 to 95 wt % of castor meal; 1 to 50 wt % of rice meal; and 4 to 80 wt % of one or more of rapeseed oil meal, palm oil meal, and processed chicken manure.

4. The fertilizer of claim 1, wherein the microorganism is at least one selected from the group consisting of the genus Bacillus, Lactobacillus, Saccharomyces, Pseudomonas, Aspergillus, Rhodotorula, Streptomyces, and Thermoascus.

5. The fertilizer of claim 1, wherein the organic fertilizer is in the form of pellets or granules.

6. A method of preparing a microorganism-coated organic fertilizer, the method comprising:
(a) kneading and grinding organic raw materials;
(b) preparing an organic fertilizer by molding the mixture of step (a) into pellets or granules;
(c) inputting the organic fertilizer into a cylindrical rotating housing that is inclined to form a downward slope from the inlet to the outlet and rotates at a predetermined speed by external power; and
(d) forming and drying a microbial coating layer, which covers 90 area % or more of the organic fertilizer surface, by spraying a microbial culture solution while supplying hot air to the inside of the cylindrical rotating housing.

7. The method of claim 6, wherein the moisture content of the organic fertilizer input into the cylindrical rotating housing in step (c) is 16 to 24%.

8. The method of claim 6, wherein in step (d), the spraying of the microbial culture solution is performed by a spray nozzle, in which a plurality of spray holes are formed, and the length of the spray nozzle is ⅓ or less of the length of the cylindrical rotating housing.

9. The method of claim 6, wherein the temperature of the hot air supplied in step (d) is 35 to 80° C.
